(19) United States
(12) Patent Application Publication
(10) Pub. No.: US 2019/0318036 A1
(43) Pub. Date: Oct. 17, 2019

(54) Topic Based Publish and Parametric Subscribe Pattern

(71) Applicant: Wind River Systems, Inc., Alameda, CA (US)

(72) Inventor: Ionut POPA, Galati (RO)

(21) Appl. No.: 15/950,896

(22) Filed: Apr. 11, 2018

(51) Int. Cl. G06F 17/30; H04W 88/16; H04W 8/18

(52) U.S. Cl. CPC G06F 17/30867; H04W 8/18; G06F 17/30616; H04W 88/16

(57) ABSTRACT

A device, system, and method determine a topic based publish and parametric subscribe pattern. The method performed at a gateway of a communications network includes receiving a subscriber request, the subscriber request including a plurality of terms, the terms associated with a topic keyword of the subscriber request, a combination of the terms associated with a parameter of the subscriber request. The method includes receiving a published content item that corresponds to the topic keyword, the published content item including information used to address the request based on the parameter. The method includes generating a further published content item including a result based on the topic keyword, the parameter, and the information.

### BACKGROUND INFORMATION

An electronic device may be configured to establish a connection to a plurality of different networks or types of networks as well as with other electronic devices to perform a variety of different functionalities via the connection. For example, when the electronic device is a handheld device such as a smartphone or tablet used by a user, the electronic device may connect to a network to communicate with another electronic device through the network connection (e.g., a user of the electronic device may perform a voice call or transmit a text to another user of another electronic device). In another example, the electronic device may connect to the network to receive browser data from servers or other electronic devices while using a browser application on the electronic device.

In using the network connection for any reason, the electronic device may transmit a request and receive corresponding data. For example, the user may input a request on the browser application running on the electronic device and results from a search may be provided to the user. In a conventional publish and subscribe paradigm in which a search request is used to provide results, a central node referred to as a gateway may receive and process the request as well as forward the results. The gateway may receive independent information from publishers for respective published content items which may be categorized into general topics. For example, the topics may be hierarchical labels. Thus, when the gateway receives a request for published content from a subscriber, the terms of the request may be parsed and matched to the topics to generate the results.

When the request is relatively simple (e.g., a one term input), the gateway used by the browser application may utilize this single term as the topic and review published content to identify matching results having this topic, which are returned to the requesting subscriber of this content. As the request becomes more complex or more specific (e.g., from a one term input to a phrase or question), the gateway may parse the request to identify the topics and determine the matching published content items. However, the results of the published content items may include entries which are irrelevant or only partially/tangentially related to the intended request. Although the gateway may include further features such as a filter to remove unnecessary terms as topics, the results of the published content items is only based on a topic match. Thus, with increases to complexity or specificity in the requests, the probability that a relevant or exact result is found and returned to the user decreases.

### SUMMARY

The exemplary embodiments are directed to a method for a publish and subscribe mechanism performed at a gateway of a communications network. The method includes receiving a subscriber request where the subscriber request includes a plurality of terms that are associated with a topic keyword of the subscriber request and where a combination of the terms is associated with a parameter of the subscriber request. The method includes receiving a published content item that corresponds to the topic keyword where the published content item includes information used to address the request based on the parameter. The method includes generating a further published content item including a result based on the topic keyword, the parameter, and the information.

The exemplary embodiments are directed to a gateway performing a publish and subscribe mechanism. The gateway includes a transceiver configured to connect to a publishing entity and a subscriber entity. The transceiver is configured to receive a subscriber request that includes a plurality of terms where the terms are associated with a topic keyword of the subscriber request and where a combination of the terms is associated with a parameter of the subscriber request. The transceiver is configured to receive a published content item that corresponds to the topic keyword where the published content item includes information used to address the request based on the parameter. The gateway includes a processor generating a further published content item including a result based on the topic keyword, the parameter, and the information.

The exemplary embodiments are directed to a non-transitory computer readable storage medium with an executable program stored thereon, wherein the program instructs a microprocessor to perform operations associated with a publish and subscribe mechanism. The operations include receiving a subscriber request including a plurality of terms associated with a topic keyword of the subscriber request where a combination of the terms is associated with a parameter of the subscriber request. The operations include receiving a published content item that corresponds to the topic keyword where the published content item includes information used to address the request based on the parameter. The operations include generating a further published content item including a result based on the topic keyword, the parameter, and the information.

### BRIEF DESCRIPTION OF THE DRAWINGS

FIG. 1 shows an example system to publish and subscribe content according to various exemplary embodiments described herein.

FIG. 2 shows an example gateway including a servlet in the system of FIG. 1 according to various exemplary embodiments described herein.

FIG. 3 shows an example exchange arrangement to publish and subscribe content according to various exemplary embodiments described herein.

FIG. 4 shows an example method to publish and subscribe content according to various exemplary embodiments described herein.

### DETAILED DESCRIPTION

The exemplary embodiments may be further understood with reference to the following description and the related appended drawings, wherein like elements are provided with the same reference numerals. The exemplary embodiments are related to a device, a system, and a method for providing a result based on published content items from one or more publishers to a subscriber requesting the result. Specifically, the exemplary embodiments relate to a publish and subscribe mechanism in which a pre-processing operation is used to utilize published content items to generate results for a request. By processing the request as well as processing the available published content items, the exemplary embodiments are configured to generate a proper result to a corresponding request rather than merely push matching data from a publisher to the subscriber.

As those skilled in the art will understand, the conventional publish and subscribe paradigm may provide results having many entries that have no relevance or do not properly address the request. Specifically, the conventional paradigm uses a topic matching mechanism where published content items from publishers and requests from subscribers are broken down into topics. Thus, a gateway processing the requests and results may match topics from requests to topics from published content items and determine results. However, a particular topic may have a plurality of different facets. Thus, a first published content item of a first topic may relate to a first facet while a second published content item of the first topic may relate to a second, entirely different facet. Despite these different facets, both published content items may be categorized with the first topic identifier. Therefore, the conventional paradigm may receive a request for the first facet but still return results including both the first and second published content items. For example, the request may query to an average weather condition during a particular week of the year. Thus, the request may be determined to include a topic of “weather.” The conventional paradigm may still provide a result of a published content item regarding expected weather patterns based on a current trajectory in view of presently existing conditions. Although this result has no bearing on the request, such a published content item may still be determined to match the request as the topic identifier of this published content item may include “weather.” As for many use-cases, the gateway of the conventional paradigm is payload agnostic where the result may be any structured content that simply passes through from publishers to subscribers.

In view of how the conventional paradigm operates, the request may not be properly addressed and superfluous, unnecessary results may also be provided. In this manner, undue transmissions may also be performed for these results. The exemplary embodiments are configured to more efficiently respond to requests by providing a proper result to a request and using transmissions that correspond to the request and result. Specifically, transmissions to the requesting subscriber may be streamlined. As will be described in further detail below, the request from a subscriber may, at run time, dynamically instruct a servlet of the gateway to perform additional processing of time-series sensor data for a specific subscription of content based on a set of parameters that are specified in the request. Furthermore, the servlet may provide a corresponding extension mechanism for the gateway to handle and delegate configurable subscription requests. The gateway may forward the request to the servlet which subscribes to at least one topic, aggregates/processes published content items from the publishers, and publishes a processed result using the original parametric subscription topic. In this manner, the gateway including the servlet is no longer payload agnostic and becomes aware of payload structure to be able to extract and process the data involved in the publish and subscribe mechanism.

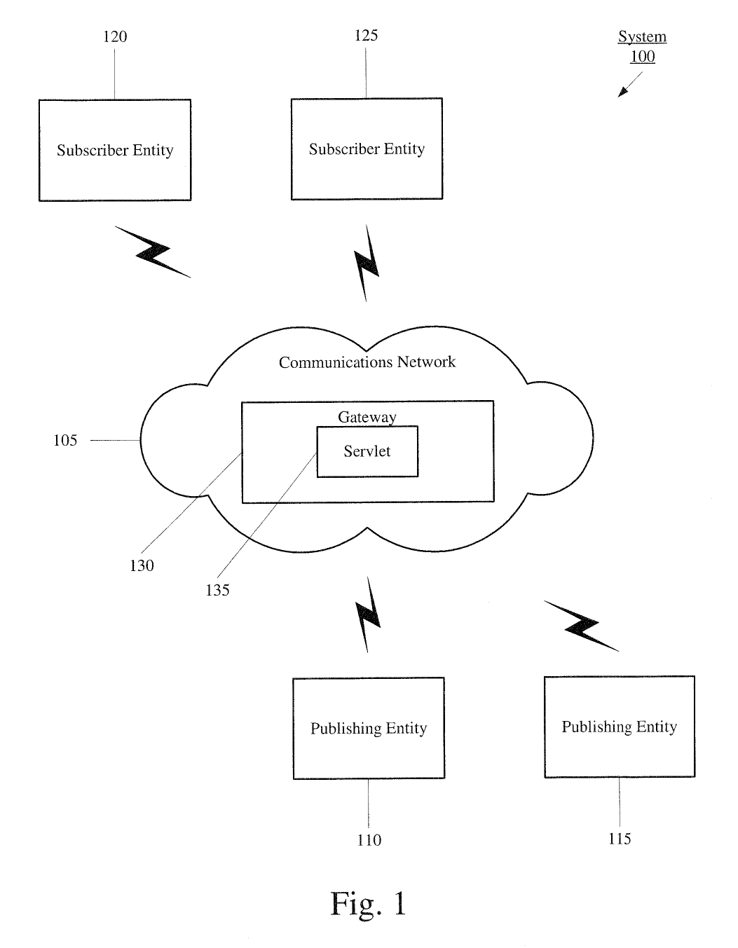

FIG. 1 shows a system 100 to publish and subscribe content according to various exemplary embodiments described herein. The system 100 shows a communication network 105 in which a data transmission may be performed between two or more electronic devices. As illustrated, the electronic devices in the system 100 may be used by publishing entities 110, 115 and subscriber entities 120, 125. For illustrative purposes, the publishing entities 110, 115 and the subscriber entities 120, 125 are intended to represent the electronic devices used in performing a network communication. For example, those skilled in the art will understand the different electronic devices that may be used (e.g., a computer, a router, etc.) and the components of these electronic devices (e.g., transceiver). It is also noted that the publishing entities 110, 115 and the subscriber entities 120, 125 may connect to the communications network 105 using any mechanism (e.g., via a base station).

The communications network 105 may represent any network to which one or more of the electronic devices used by the publishing entities 110, 115 and the subscriber entities 120, 125 may connect for operations to be performed over the communications network 105 such as data transmissions (e.g., requesting content and providing published content items). For example, the communications network 105 may be a wireless network in which one or more of the electronic devices connect using a wireless connection, a wired network in which one or more of the electronic devices connect using a wired connection, a combination thereof, etc. The communications network 105 may also represent any type of network such as a cellular network (e.g., 3G, 4G, LTE, etc.), a WiFi network, a HotSpot, a local area network (LAN), a wide area network (WAN), etc., or multiple connected networks.

The electronic devices of the publishing entities 110, 115 and the subscriber entities 120, 125 may represent any set of devices that may communicate with one another via the communications network 105 so that transmissions may be exchanged between two or more of the electronic devices and with network components of the communications network 105. It is noted that the system 100 including two publishing entities 110, 115 and two subscriber entities 120, 125 is only exemplary. Those skilled in the art will understand that the system 100 may include any number of entities and each entity may include any number of electronic devices.

The communications network 105 may enable data to be exchanged among the publishing entities 110, 115, the subscriber entities 120, 125, and network components of the communications network 105. The communications network 105 may include a plurality of network components that provide respective features in the publish and subscribe mechanism. Specifically, according to the exemplary embodiments, the communications network 105 may include a gateway 130 which may incorporate a servlet 135. It is noted that the gateway 130 and the servlet 135 may be represented in a variety of different manners. For example, the gateway 130 and the servlet 135 may be physical components that reside in the communications network 105 between the electronic devices. In another example, the functionalities of the gateway 130 and the servlet 135 may be incorporated into the communications network 105. The exemplary embodiments may utilize any manner of including the features of the gateway 130 and the servlet 135 to provide the publish and subscribe mechanism according to the exemplary embodiments.

The gateway 130 may represent any combination of hardware, software, and/or firmware used to perform network operations. The gateway 130 may be a network node configured to interface with a further communications network that uses different protocols as the communications network 105. Thus, the gateway 130 may be an intermediary device or functionality that negotiates and handles data transmissions. The gateway 130 may comprise sub-components and/or functionalities including protocol translation, impedance matching, rate conversion, fault isolation, signal translation, etc. to provide interoperability. The gateway 130 may perform the functionalities at any network layer.

With regard to the publish and subscribe mechanism associated with web browsers and published content items on the Internet, the publishing entities 110, 115 may be host nodes that include the electronic devices that serve webpages to the subscriber entities 120, 125 while the gateway 130 may include intermediary nodes that connect the networks between the publishing entities 110, 115 and the subscribe entities 120, 125. For example, the electronic devices that manage traffic between networks used by Internet Service Providers (ISPs) to connect users to the Internet may be gateway nodes. In another example, in an enterprise implementation, a server acting as a gateway node may be additionally acting as a proxy server and a firewall server. Thus, a gateway node may be associated with a router (e.g., which is aware of how to direct a given packet of data that arrives at the gateway) and a switch (e.g., which furnishes an actual path in and out of the gateway for a given packet).

The servlet 135 may be a functionality of the gateway 130. For example, the servlet may be an applet (e.g., Java based) that runs within the gateway 130 which provides a server environment. The servlet 135 may extend the functionalities and capabilities of the gateway 130. According to the exemplary embodiments, the servlet 135 may provide processing capabilities for requests from the subscribing entities 120, 125 and published content items from the publishing entities 110, 115. The servlet 130 may be persistent. That is, once started, the servlet 130 may remain in a memory of the gateway 130 and fulfill requests. The persistence of the servlet 135 may also provide a more efficient performance as there is no additional time used in initiating and tearing down (as would be required for common gateway interfaces). In a particular implementation, the servlet 135 may be modular code, implementing a specific interface, probed by the gateway 130 during an initialization process and executed by the gateway 130 on specific events.

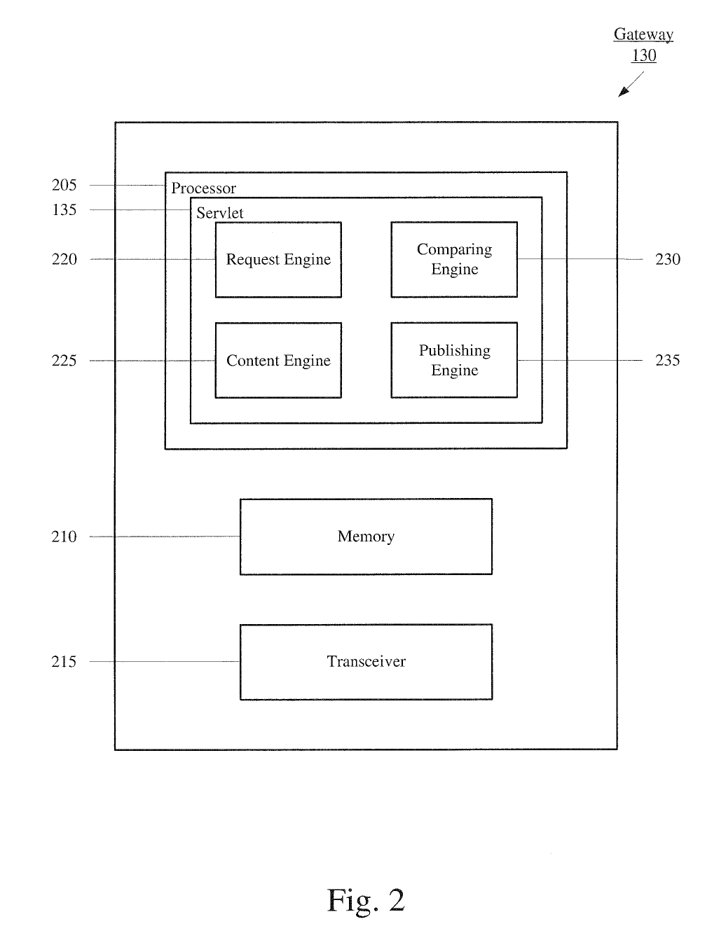

FIG. 2 shows the gateway 130 including the servlet 135 in the system 100 of FIG. 1 according to various exemplary embodiments described herein. The gateway 130 may be configured to execute applications and perform operations using computer-executable instructions in providing the above described functionalities of the gateway 130. Additionally, according to the exemplary embodiments, the gateway 130 may include extended functionalities via the servlet 135 which is illustrated as an application executed by the gateway 130. As noted above, the gateway 130 may be implemented as a network component (e.g., a server). The gateway 130 may include a processor 205, a memory 210, and a transceiver 215. The gateway 130 may further include one or more of the following: a display device, an input/output (I/O) device, and other suitable components, such as, for example, a portable power supply, an audio I/O device, a data acquisition device, ports to electrically connect the gateway 130 to other electronic devices, etc.

The processor 205 may be configured to execute computer-executable instructions for operations from a plurality of applications that provide various functionalities of the gateway 130. For example, the plurality of applications may include programs including those used in the above identified operations, particularly with regard to the publish and subscribe mechanism. In another example, the applications may include the servlet 135 that provides the features according to the exemplary embodiments in which processing of published content items from the publishing entities 110, 115 and requests are performed prior to providing results to the requesting subscriber entity 120, 125. In providing these features, the servlet 135 may include a request engine 220, a content engine 225, a comparing engine 230, and a publishing engine 235. The request engine 220 may be configured to process requests from the subscriber entities 120, 125. The content engine 225 may be configured to process published content items from the publishing entities 110, 115. The comparing engine 230 may be configured to identify published content items that are relevant to the request. The publishing engine 235 may be configured to generate a further published content item that addresses the request.

It should be noted that the above noted engines each being an application (e.g., a program) executed by the processor 205 is only exemplary. The functionality associated with the engines may also be represented as a separate incorporated component of the gateway 130 or may be a modular component coupled to the gateway 130, e.g., an integrated circuit with or without firmware. For example, the integrated circuit (which may embody the servlet 135) may include input circuitry to receive signals and processing circuitry to process the signals and other information. In addition, the functionality described for the processor 205 may be split among two or more processors. The exemplary embodiments may be implemented in any of these or other configurations of a gateway.

The memory 210 may be a hardware component configured to store data related to the functionalities performed by the gateway 130. For example, the memory 210 may store processing data and metadata associated with a request and published content items. The transceiver 215 may provide conventional functionalities. For example, the transceiver 215 may enable a connection or a communication to be established with the publishing entities 110, 115 and the subscriber entities 120, 125.

The request engine 220 may process requests from the subscriber entities 120, 125. Initially, the request engine 220 may perform an initial processing operation of any request that is received to determine if an extension indicator is included in the request. When submitting a request, the subscriber entities 120, 125 may be presented with an option to utilize the features of the exemplary embodiments. Thus, a user associated with the subscriber entities 120, 125 may enter terms in the request and may additionally enter an input indicating whether the publish and subscribe mechanism according to the exemplary embodiments is to be utilized or whether the conventional publish and subscribe paradigm is to be utilized. For example, for relatively simple request terms (e.g., one term requests), the conventional paradigm may provide the proper results. However, with more complex request terms, phrases, or particulars, the conventional paradigm may not provide the proper results and the publish and subscribe mechanism according to the exemplary embodiments may be better suited to handle this request.

With the conventional paradigm and the mechanism according to the exemplary embodiments being available to be performed by the gateway 130, the request engine 220 and the content engine 225 may perform corresponding operations. As noted above, in the conventional publish and subscribe paradigm, a request may be provided from the subscriber entities 120, 125 which is parsed into topic keywords. Published content items from the publishing entities 110, 115 may also be associated with topic keywords. Thus, the gateway 130 may process the request to determine one or more topic keywords and identify one or more published content items that include the same topic keywords. According to a first exemplary embodiment, the topic keywords of the content items may have been included prior to being received by the gateway 130. Thus, the publishing entities 110, 115 may have included the topic keywords. According to a second exemplary embodiment, the gateway 130 may be configured to analyze the published content items and determine the topic keywords. For example, the content engine 225 may be configured with this further functionality. Accordingly, in a substantially similar manner as how the request engine 220 determines the topic keywords in the request, the content engine 225 may perform an operation to determine the topic keywords that are associated with the respective published content item. With no extension indicator, the conventional publish and subscribe paradigm may be used and the gateway 130 may return the matching results based on topic keywords.

When the request engine 220 receives a request and determines that the extension indicator is included, the servlet 135 may perform corresponding operations associated with the publish and subscribe mechanism according to the exemplary embodiments. Once the gateway 130 forwards the request to the servlet 135, the request engine 220 may determine topic keywords and parameters that are included in the request. In contrast to the simplified determination of determining topic keywords, the parameters of the request may be determined using various analytical processes. For example, the request engine 220 may be configured with natural language processing, form identification, etc. Examples of how parameters are determined and used by the servlet 135 will be described in further detail below.

The content engine 225 may also be configured to analyze content in the published content items. Thus, information in the content may be extracted as needed. Accordingly, the content engine 225 may also include functionalities substantially similar to the request engine 220 with regard to determining beyond merely keywords. It is noted that the content engine 225 may be analyzing the published content items at various times. In a first example, the content engine 225 may receive published content items from the publishing entities 110, 115 at predetermined intervals (including existing published content items that are updated). Thus, the content engine 225 may maintain a registry of published content items that may be used for the publish and subscribe mechanism according to the exemplary embodiments. In several examples, the content engine 225 may perform this operation as the published content items become available, at predetermined intervals, etc. In a second example, the content engine 225 may analyze published content items when requests are received by the servlet 135.

Once the request engine 220 has determined the topic keywords as well as the parameters of the request received from the subscriber entities 120, 125 and based on analyzing published content items from the publishing entities 110, 115, the comparing engine 230 may identify published content items that are relevant to the request. With regard to the publish and subscribe mechanism according to the exemplary embodiments, the comparing engine 230 may first utilize the keyword topics to filter the published content items and identify the published content items that may potentially provide information that correspond to the parameters. Subsequently, the comparing engine 230 may utilize the parameters to determine how the request is to be addressed based on the information of the filtered published content items. In a simplified example, one or more published content items may provide individual values at known times. The request, however, may include parameters that identify that an average is being queried. The conventional publish and subscribe paradigm may result in these one or more published content items each being provided. However, the comparing engine 230 may determine the published content items that match the keyword parameters so that the filtered published content items may be used to address the request according to the publish and subscribe mechanism of the exemplary embodiments.

The publishing engine 235 may generate a further published content item that addresses the request. Based on the output of the comparing engine 230, the publishing engine 235 may perform any further operations to directly address the request. Returning to the example above about an average value, the comparing engine 230 may have provided information associated with the parameters such as the individual values, the corresponding times, and any time frame over which the average is to be determined (e.g., based on a parameter specified in the request, based on an arbitrary period if unspecified, etc.). The publishing engine 235 may be configured to utilize the information from the comparing engine 230 and generate a result that directly addresses the request by the subscribing entity 120, 125.

The publishing engine 235 may also be configured to format the result into the further published content item. For example, based on the application (e.g., web browser, news services, etc.) being used on the source of the request (e.g., one of the subscriber entities 120, 125) to provide the request, the publishing engine 235 may generate corresponding data to be used in creating an appropriate user interface that displays the result on the subscriber entity 120, 125. In a particular example, when the application is a web browser, a result webpage that is displayed from entering a search query may include the result from the servlet 135 on this webpage. In another particular example, the publishing engine 235 may generate a link to be included in the result that may be selected by the user of the subscriber entity 120, 125 that leads to webpage generated by the servlet 135 that includes the result. In this manner, the servlet 135 may be configured to provide the results that directly addresses the request using any mechanism that allows the user of the subscriber entities 120, 125 to view the result.

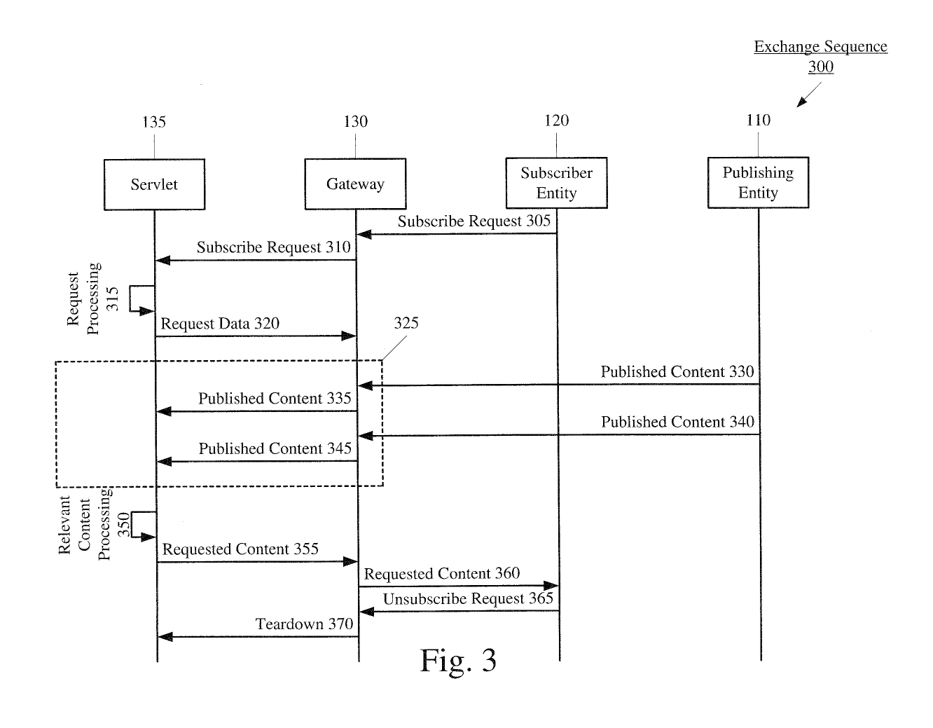

FIG. 3 shows an exchange sequence 300 to publish and subscribe content according to various exemplary embodiments described herein. The exchange sequence 300 illustrates an exemplary set of data transmissions between the components of the system 100. For illustrative purposes, the request may originate from the subscriber entity 120 while the published content may originate from the publishing entity 110 (e.g., which may comprise a plurality of publishing sources). The exchange sequence 300 may also include the gateway 130 and the servlet 135. Although the servlet 135 is shown separate from the gateway 130, as noted above, the servlet 135 may be an extension of the gateway 130 and may also be incorporated in the gateway 130. As will be described in further detail below, the exchange sequence 300 is only exemplary of when the data transmissions are performed. That is, the exchange sequence 300 may utilize a different timing of when the data transmissions may be performed.

A first set of operations that may be performed may be for the request. Thus, a user of the subscriber entity 120 may enter terms into an application that transmits 305 a subscribe request to the gateway 130. As noted above, the user of the subscriber entity 120 may select to utilize the publish and subscribe mechanism according to the exemplary embodiments. Thus, the subscribe request may include the extension indication. When the gateway 130 receives the subscribe request, the gateway 130 may process the subscribe request and determine that the extension indication is included. Thus, the gateway 130 may forward 310 the subscribe request to the servlet 135. The use of the publish and subscribe mechanism according to the exemplary embodiments may be a manually selected feature or an automatically selected feature. For example, when entering the terms of a request, a user may also include an input that selects use of the publish and subscribe mechanism according to the exemplary embodiments. In another example, the publish and subscribe mechanism may be a configuration of the gateway that is automatically selected.

When the servlet 135 receives the subscribe request, the servlet 135 may process 315 the subscribe request. In performing this operation, the servlet 135 may determine topic keywords and parameters that are included in the subscribe request. For example, the servlet 135 may utilize parsing techniques to determine the topic keywords and utilize natural language processing techniques to determine the parameters. Once the subscribe request is processed by the servlet 135, the servlet 135 may transmit 320 request data back to the gateway 130. For example, the request data may include the topic keywords to match published content (as described below). It is noted that the subscribe request 310 may be forwarded by the gateway 130 to the servlet 135 in the form as received in the subscribe request 310 including the topic keywords and parameters. However, the servlet may transmit 320 the data request as a subscription request but including only the topic keywords.

At a time prior or during the subscribe request from the subscriber entity 120, a set of operations 325 may be performed. The operations 325 may relate to when the publishing entity 110 creates published content items. Thus, at various times, the publishing entity 110 may transmit 330, 340 published content items to the gateway 130. According to an exemplary embodiment, the topic keywords included in the request data provided by the servlet 135 may allow the gateway 130 to perform an initial filtering of the published content items. For example, a substantially similar operation used in the conventional publish and subscribe paradigm may be used where results of published content items that would be provided as results are instead forwarded 335, 340 to the servlet 135.

When the servlet 135 receives the filter published content items from the gateway 130, the servlet 135 may process 350 the published content items based on the parameters that are determined from the processing 315. In this manner, the servlet 135 may directly address the query contained in the subscribe request. Thus, the servlet 135 may utilize the published content items from the publishing entities 110, 115 and the parameters of the request to generate and provide the further published content item for the subscriber entities 120, 125. Thereafter, the servlet 135 may generate a further published content item that is transmitted 355 to the gateway 130 and forwarded 360 to the subscriber entity 120 that originally provided the subscribe request. To complete the publish and subscribe exchange sequence 300, the subscriber entity 120 may transmit 365 an unsubscribe request to teardown 370 the connection to the gateway 130.

The publish and subscribe mechanism according to the exemplary embodiments may be used when a request from the subscriber entities 120, 125 includes parameters beyond the terms that are entered in the request. For example, a relatively complex request or a combination of the terms used in the request that include a further meaning beyond the individual words may cause the conventional publish and subscribe paradigm to generate irrelevant or only partially relevant results. As noted above, the publish and subscribe mechanism according to the exemplary embodiments provide results that directly address the request. The examples described below generally refer to sensors and sensor values. Those skilled in the art will understand that the sensors and sensor values may refer to any measurable metric.

In a first example, the publish and subscribe mechanism according to the exemplary embodiments may be used when averaging sensor values. For example, the publishing entities 110, 115 may report vehicle speed data at fixed intervals. However, the subscriber entities 120, 125 may require an average speed value using an arbitrary interval. Accordingly, the parameters from the request may be identified as a speed value in which an average is to be ascertained over some undefined interval which will be defined by the servlet 135. Through information extracted from the published content items, the servlet 135 may determine the average vehicle speed value and provide this result to the subscriber entities 120, 125. It is noted that in this example, there may be multiple subscriber entities 120, 125 using different parameters (e.g., ones that include the interval, ones that indicate a specific location, etc.) for the same subscription. It is also noted that there may be a plurality of other factors that are considered in providing the result (e.g., location, type of vehicle, etc.).

In another example, the publishing entities 110, 115 may report individual temperatures for a set of days. However, the request may be identified as a temperature value in which an average is to be ascertained over a defined interval (e.g., selected days) at a given location. In a specific example, the request may request the average temperature value of a city over an identified period of days (e.g., Monday, Tuesday, and Wednesday) of a given week. Using the individual temperatures from the published content of the publishing entities 110, 115, the servlet 135 may determine the average temperature value and provide this result to the subscriber entities 120, 125.

In a second example, the publish and subscribe mechanism according to the exemplary embodiments may be used when filtering sensor values. For example, the publishing entities 110, 115 may report temperature values at fixed intervals. However, the subscriber entities 120, 125 may require temperature values only when above a specific threshold that may be defined or undefined. Accordingly, the parameters from the request may be identified as a temperature value that must satisfy the threshold requirement which may be indicated or selected by the servlet 135. Through information extracted from the published content items, the servlet 135 may select the temperature values at the fixed intervals that satisfy the threshold requirement and provide these results to the subscriber entities 120, 125.

In a third example, the publish and subscribe mechanism according to the exemplary embodiments may be used when conditional sensor data retrieval is based on another sensor value. For example, the publishing entities 110, 115 may report vehicle speed data and engine rotations per minute (RPM). However, the subscriber entities 120, 125 may require speed values only when the RPM is above a threshold. Accordingly, the parameters from the request may be identified as a speed value only when the corresponding RPM at that speed value is above a specific threshold that may be defined or undefined. Through information extracted from the various published content items, the servlet 135 may select the speed values that satisfy the RPM threshold requirement and provide these results to the subscriber entities 120, 125.

In a fourth example, the publish and subscribe mechanism according to the exemplary embodiments may be used when averaging multiple sensor topics in a single servlet. For example, the publishing entities 110, 115 may report vehicle speed data and engine RPM. However, the subscriber entities 120, 125 may require an average value of any vehicle that has a speed that must be above a RPM threshold for an arbitrary interval. Accordingly, the parameters from the request may be identified as a speed value in which an average is to be ascertained for speed values only when the corresponding RPM at that speed value is above a specific threshold that may be defined or undefined over some undefined interval which will be defined by the servlet 135. Through information extracted from the various published content items, the servlet 135 may select the speed values that satisfy the RPM threshold requirement, average these values to determine the average speed value, and provide these results to the subscribe entities 120, 125.

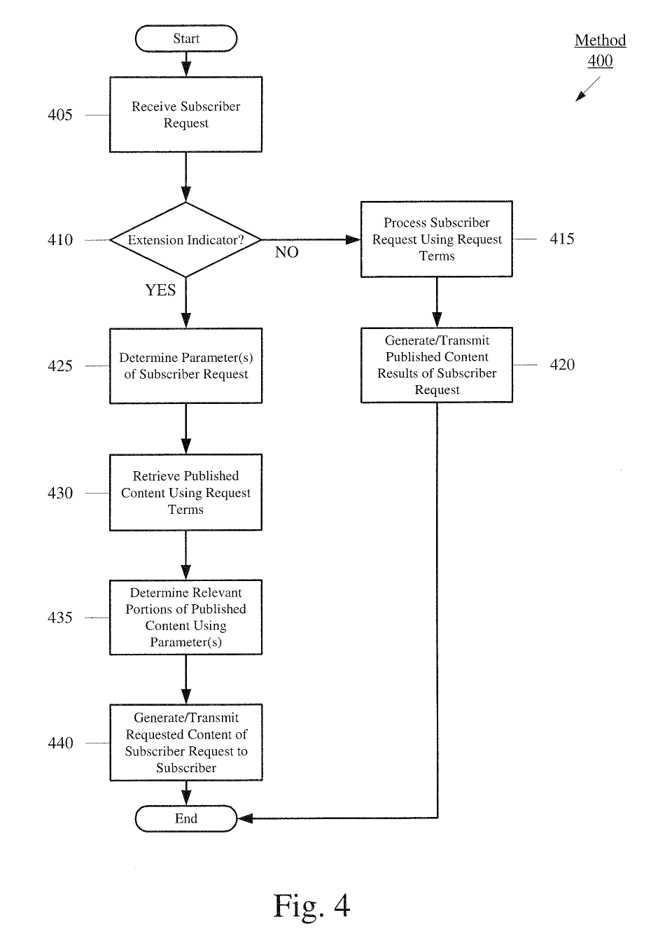

FIG. 4 shows a method 400 to publish and subscribe content according to various exemplary embodiments described herein. Specifically, the gateway 130 may include an extension functionality via the servlet 135 that provides for a pre-processing operation to be performed on requests from subscribers based on published content items. The method 400 may be performed by the request engine 220, the content engine 225, the comparing engine 230, and the publishing engine 235 of the servlet 135. The method 400 will be described with regard to the system 100 of FIG. 1 and the servlet 135 of FIG. 2.

In 405, the gateway 130 receives a subscriber request from one of the subscriber entities 120, 125. A user associated with the subscriber entities 120, 125 may enter terms as the subscriber request that is transmitted to the gateway 130. The terms may be randomly selected terms or may be organized in a way that specifies what is being requested.

In 410, the gateway 130 determines whether the request may include an extension indicator. The extension indicator may identify whether the request is to be processed using the conventional publish and subscribe paradigm or using the publish and subscribe mechanism according to the exemplary embodiments. If the extension indicator is absent, the gateway 130 continues to 415 to use the conventional publish and subscribe paradigm. Thus, in 415, the gateway 130 processes the subscriber request and determines topic keywords. The gateway 130 may also reference available published content items from the publishing entities 110, 15 and match the topic keywords. The gateway 130 may filter the published content items in this manner and, in 420, the gateway 130 may generate and transmit the results of the published content items that matched the subscriber request using the topic keywords.

Returning to 410, if the extension indicator is present, the gate 130 continues to 425 to use the publish and subscribe mechanism according to the exemplary embodiments. Thus, in 425, the gateway 130 via the servlet 135 determines parameters that are included in the subscriber request (e.g., using natural language processing techniques). In 430, the gateway 130 via the servlet 135 retrieves published content items using the topic keywords in a substantially similar manner as performed in 415. Again, it is noted that the retrieving of the published content items may be performed at different times may not necessarily occur when the request has been received. In 435, the gateway 130 via the servlet 135 determines relevant portions of the filtered published content items based on the parameters of the request. The gateway 130 via the servlet 135 may determine a result using this information that directly addresses the request. Thus, in 440, the gateway 130 generates and transmits a further published content item that is provided to the subscriber entity 120, 125 that provided the subscriber request.

The exemplary embodiments provide a device, system, and method of providing a publish and subscribe mechanism in which a subscriber request is pre-processed to identify topic keywords and parameters to determine a result that is to be provided to a requesting subscriber. By extracting information in published content items that were selected using the topic keywords, the parameters may be used to further process this information to generate the result as a further published content item. The publish and subscribe mechanism according to the exemplary embodiments introduce a significant amount of flexibility for subscriber entities by providing generic mechanisms to filter and aggregate or process the data before it is received. Furthermore, multiple clients may utilize the features of the exemplary embodiments with the same data from publishing entities but filtered in different ways. By introducing a pre-processing data stage on the side of the gateway, a bandwidth between the gateway and the subscribers may also be significantly reduced.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a mobile device having an operating system such as iOS, Android, etc. In a further example, the exemplary embodiments of the above described method may be embodied as a program containing lines of code stored on a non-transitory computer readable storage medium that may be executed on a processor or microprocessor.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A method, comprising:
at a gateway of a communications network:
receiving a subscriber request, the subscriber request including a plurality of terms, the terms associated with a topic keyword of the subscriber request, a combination of the terms associated with a parameter of the subscriber request;
receiving a published content item that corresponds to the topic keyword, the published content item including information used to address the request based on the parameter; and
generating a further published content item including a result based on the topic keyword, the parameter, and the information.

2. The method of claim 1, further comprising:
determining whether the subscriber request includes an extension indicator, the extension indicator identifying whether the subscriber request is to be processed to identify the topic keyword and the parameter or the subscriber request is to be processed to identify only the topic keyword.

3. The method of claim 2, wherein the extension indicator is associated with an extension functionality of a servlet of the gateway.

4. The method of claim 1, further comprising:
filtering a plurality of available published content items based on the topic keyword, the filtering resulting in the published content item.

5. The method of claim 4, wherein the filtering the plurality of available published content items is performed one of prior to or when the subscriber request is received.

6. The method of claim 1, wherein the subscriber request is received from a subscriber entity and the published content item is received from a publishing entity.

7. The method of claim 7, further comprising:
transmitting the further published content item to the subscriber entity.

8. The method of claim 1, wherein the topic keyword is determined using a parsing operation.

9. The method of claim 1, wherein the parameter is determined using a natural language processing operation.

10. The method of claim 1, wherein the subscriber request is one of a first average sensor value over an arbitrary interval, a first sensor value when above a first specific threshold, a second sensor value when a third sensor value is relative a second specific threshold, or a second average sensor value where each individual ones of the sensor values used to determine the average are relative to a third specific threshold and over an arbitrary interval.

11. A gateway, comprising:
a transceiver configured to connect to a publishing entity and a subscriber entity, the transceiver configured to receive a subscriber request, the subscriber request including a plurality of terms, the terms associated with a topic keyword of the subscriber request, a combination of the terms associated with a parameter of the subscriber request, the transceiver configured to receive a published content item that corresponds to the topic keyword, the published content item including information used to address the request based on the parameter; and
a processor generating a further published content item including a result based on the topic keyword, the parameter, and the information.

12. The gateway of claim 11, wherein the processor determines whether the subscriber request includes an extension indicator, the extension indicator identifying whether the subscriber request is to be processed to identify the topic keyword and the parameter or the subscriber request is to be processed to identify only the topic keyword.

13. The gateway of claim 12, wherein the extension indicator is associated with an extension functionality of a servlet of the gateway.

14. The gateway of claim 11, wherein the processor filters a plurality of available published content items based on the topic keyword, the filtering resulting in the published content item.

15. The gateway of claim 14, wherein the filtering the plurality of available published content items is performed one of prior to or when the subscriber request is received.

16. The gateway of claim 11, wherein the transceiver is configured to transmit the further published content item to the subscriber entity.

17. The gateway of claim 11, wherein the topic keyword is determined using a parsing operation.

18. The gateway of claim 11, wherein the parameter is determined using a natural language processing operation.

19. The gateway of claim 11, wherein the subscriber request is one of a first average sensor value over an arbitrary interval, a first sensor value when above a first specific threshold, a second sensor value when a third sensor value is relative a second specific threshold, or a second average sensor value where each individual ones of the sensor values used to determine the average are relative to a third specific threshold and over an arbitrary interval.

20. A non-transitory computer readable storage medium with an executable program stored thereon, wherein the program instructs a microprocessor to perform operations comprising:
receiving a subscriber request, the subscriber request including a plurality of terms, the terms associated with a topic keyword of the subscriber request, a combination of the terms associated with a parameter of the subscriber request;
receiving a published content item that corresponds to the topic keyword, the published content item including information used to address the request based on the parameter; and
generating a further published content item including a result based on the topic keyword, the parameter, and the information.
